(19) United States
(12) Patent Application Publication
(10) Pub. No.: US 2014/0059749 A1
(43) Pub. Date: Mar. 6, 2014

(54) First Responder Protective Uniform

(71) Applicants: Mustapha S. Fofana, Paxton, MA (US); Neil Blakington, Worcester, MA (US); Steven Haynes, Worcester, MA (US)

(72) Inventors: Mustapha S. Fofana, Paxton, MA (US); Neil Blakington, Worcester, MA (US); Steven Haynes, Worcester, MA (US)

(21) Appl. No.: 14/012,553

(22) Filed: Aug. 28, 2013

Related U.S. Application Data
(60) Provisional application No. 61/693,914, filed on Aug. 28, 2012.

(51) Int. Cl. A62B 17/00

(52) U.S. Cl. CPC A62B 17/006
USPC 2/457

(57) ABSTRACT

A protective garment comprising a plurality of layers integrated or bonded in a complementary manner protects wearers such as emergency responders against multiple hazards often present in a response area. The layers include a toxicity barrier adapted for visual contrast with toxic substances, such that the toxicity is barrier responsive to toxic substances by varying a response to an optical signal such as a UV light. An impact layer is responsive to projectiles by controlled deformation, such that the controlled deformation prevents passage of the projectile, as EMT response areas are often unsecured crime scenes where firearms may be present. Also, an absorbent layer is responsive to expelled fluids of the wearer such as perspiration, in which the absorbent layer is adapted for unidirectional diffusion of fluids so that moisture does not remain in contact with the skin of the wearer and cause discomfort, irritation, and thermal imbalance.

### CROSS REFERENCE TO RELATED APPLICATIONS

This application claims the benefit of the filing date of earlier filed U.S. Provisional Application Ser. No. 61/693,914, filed Aug. 28, 2012, entitled “FIRST RESPONDER PROTECTIVE UNIFORM,” the teachings, disclosures and contents of which are incorporated herein by reference in entirety.

### BACKGROUND

Emergency responders such as EMTs (Emergency Medical Technicians) are often called into hazardous and/or unknown environments, and encounter a variety of threats, including violent persons, weapons, gunfire, contaminants, and toxic substances. As EMTs are often called simultaneously with other first responders such as police and fire, they may arrive before the response area is secured from hostile influences and/or hazards. Modern technology which facilitates deployment of first responders to exigent circumstances facilitates rapid deployment of specialized teams, which increases the number of personnel and corresponding uniformed apparel, potentially leading to additional confusion and visual ambiguity for identifying the function of particular responders, increasing the chaotic nature of the situation.

### SUMMARY

A protective garment comprising a plurality of layers integrated or bonded in a complementary manner protects wearers such as emergency responders against multiple hazards and contaminants often presented in a response area. The layers include a toxicity barrier adapted for visual contrast with toxic substances, such that the toxicity is barrier responsive to contaminants and toxic substances by varying a response to an optical signal such as a UV light. An impact layer is responsive to projectiles by controlled deformation, such that the controlled deformation and delay pressure force slows down the passage of the projectile, as EMT response areas are often unsecured crime scenes where firearms may be present. Also, an absorbent layer is responsive to expelled fluids of the wearer such as perspiration, in which the absorbent layer is adapted for unidirectional diffusion of fluids so that moisture does not remain in contact with the skin of the wearer and cause discomfort, irritation, and thermal imbalance. The protective uniform also exhibits a common, accepted color scheme for identifying the function of the first responder, i.e. EMTs, police, fire and other public safety responders (such as Medical Reserve Corps, Community Emergency Response Teams, Red Cross, Emergency Management Administration, etc).

Configurations herein include a protective garment or uniform intended for use by first responders and other members of public safety responders in potentially hazardous environments. The uniform is intended to perform as a Comfortable, Operational, Reliable and Awareness focused (CORA) uniform for EMTs, paramedics and medical services first responders of all kinds. Other first responders, such as law enforcement, security and public safety, and firefighting personnel are also candidates for usage. This dedicated uniform for all seasons, denoted as CORA Emergency Medicine and Medical Services Uniforms, include a novel blend of elastic, strong soft cotton nanofabrics and minimal care cloth stock that are constructed for work and expandable maneuverings. Features of the CORA uniforms include highly visible colors resistant to fading, day/night times and built-strength for work duty, exceptional size range to meet all needs, concealed armor or wholebody shields or panels, and a breathable membrane for physiological stability of the wearer. Construction employs lightweight materials, factory sealed seams, zippers, random scaling index, a life-saving accessories backpack and/or pockets, and strong, stretchable elasticized fabrics.

Configurations herein are based, in part, on the observation that first responders such as EMTs (Emergency Medical Technicians), firefighters and police and other member of the public safety responders have no well established standard or requirements for field apparel (uniforms). Although many first responders enjoy administrative support for adequate and/or effective uniforms, such functions typically remain largely under local control of municipalities. Unfortunately, therefore, conventional approaches suffer from the shortcoming that budgetary or administrative preferences may relegate many first responders and public safety responders to conventional uniforms that may not be well suited to field demands and protection. Conventional approaches to first-responder uniforms such as EMT apparel suffer from the shortcomings of providing only a limited range of whole body motion, no use of nanofabrics and are often heavy and/or bulky, further limiting comfort and mobility, particularly in warmer ambient temperatures and mass gathering incidents.

Accordingly, configurations herein substantially overcome the above-described shortcomings of conventional EMT and first responder uniforms by providing a multi layered protective garment for shielding the wearer from various hazards often presented at accident scenes or mass gathering incidents where such services are needed. First responders must often venture into areas of uncertain hazards or threats and vulnerabilities, such as recent crime scenes and mass-gather disasters induced by man-made or natural events. Exigency of the functions of the EMS (Emergency Medical Service) and other members of public safety responders often demands timeliness, so EMTs and public safety responders may be unable to wait for law enforcement to secure an area. Therefore, hazards such as gunfire, hand weapons, blood, and any other industrial contaminants that may be present in an urban area are often factors to be contended with. Further, temperatures may be exacerbated by heat from fires or industrial mechanical factors. Also, EMTs and public safety responders are often required to bend, climb, or stretch to treat and extract victims, requiring comfort of motion. The disclosed multi layered protective garment provides a uniform that includes layers directed to each hazard and/or condition that an EMT or public safety responders may encounter. A toxicity layer guards against blood and other chemicals, and is activated by light or other stimuli to indicate contamination. An impact later includes coils, links, or other elements to protect against projectiles and blades such as gunfire and hand weapons, and an absorbent layer is in communication with the wearer's skin to allow perspiration to evaporate without allowing substances from the toxicity layer to permeate to the wearer.

Alternate configurations may include other arrangements of layers, depending on cost and protective environments sought to be protected from. The layers are integrated or bonded into a coherent textile surface for minimizing restraint of movement.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is diagram of an upper portion of the uniform;

FIG. 2 is a diagram of a lower portion of the uniform;

FIG. 3 shows layered construction of the uniform material;

FIG. 4 shows construction of a particular layer for absorbing impact;

FIG. 5 shows an alternate arrangement of the impact absorbing layer embedded in a resilient material; and

FIG. 6 shows another alternate configuration of the impact absorbing layer with interlocking elements.

### DETAILED DESCRIPTION

The configurations discussed below describe example usages and scenarios suitable for use with the protective uniform, and describe the features of the uniform beneficial in such situations. EMTs and other members of the public safety responders are often called into unstable crime scene areas or mass-gathering disaster events for tending to victims of hostile activity. The EMTs and the public safety responders themselves may then be vulnerable to the same or related entities that caused the casualty being responded to.

For example, EMTs and members of the public safety responders in unsecured areas may be subject to hazards including weapons such as firearms, knives, and other projectiles. Hostile actors or perpetrators may not be clear of the benign and non-combative nature of the presence of EMTs and the public safety responders. Violent actors may inadvertently or intentionally direct their hostilities toward the EMTs and public safety responders. In recent Mass-gathering disasters induced by man-made and natural events, homemade compression bombs loaded with shrapnel, tornadoes, earthquakes and storms all can wreak untold havocs on people and communities. There situations during and after disaster events, multiple bombs can be detonated or secondary destructions can take place in the same general area. It will not be clear to First responders and other members of the public safety responders whether additional blasts would follow, yet they are always compelled to assist those already in need of pre-hospital services in the disaster areas. Uniforms such as those disclosed herein provide protection against such projectiles and shrapnel for a sustainable response in unsecured or unstable environments.

Hazards may include toxic substances, such as blood and other bodily fluids, and substances present in the response area due to the emergency responded to, such as volatile chemicals, automotive fluids, and other materials and substances that may be present in an industrial or commercial area in which the emergency or disaster occurred. Such hazardous substances, such as those present in Hazardous Materials (HAZMAT) responses, can be absorbed by conventional EMT uniforms, and later transferred back to the wearer's skin or onto other garments and objects, for example by laundering with other clothing. Also, conventional EMT uniforms are typically of a dark color, which makes difficulty to become aware absorbed toxic materials. In the proposed approach, fibers of the toxicity barrier exhibit a change or response to toxic materials that can be detectable by an optical signal such as a UV light. In this manner, contaminated garments can be detected by quickly scanning with a handheld UV light to indicate whether the garment is free from toxic substances.

The impact layer has elastic properties and is responsive to projectiles and other weapons such as knives and blades, and deforms without yielding or rupturing in response to such stimuli. In a particular arrangement, the elastic layer embeds coil springs normal to a plane defined by the layer to increase energy absorption. Garment areas prone to movement, such as elbow and knees (skeletal joints) maintain additional or specialized structure to accommodate or avoid stress concentration at junctures where the garment layers are flexed or stretched.

The CORA uniforms, therefore, are unique unisex uniforms for EMTs, paramedics and medical first responders and public safety responders of all kinds that offer wide range of purposes, usefulness and benefits including the following features: (1) a professional, comfortable, multi-needle stitched, attractive, welcoming and recognizable appearance, (2) resistance to microbial-, water-, body sweat/fluid-, wind-, heat/temperature-, rain-, flame-, fade, abrasion, chemicals- contaminants-, and WMD-proof, (3) one-to-one fashion outlook with general population dress, (4) full range of wholebody maneuverings, (5) easy to care, transport and store, (6) wash-iron free, wash-iron and fold, (7) synthetic mesh for air-flow circulation, (8) armorbody shield T-shirt, (9) durable, safe, quality, uncertainty awareness, reliable and efficient fabrics and seams sealed, (10) easy access to storage compartments (i.e. pockets) and stationary retrievable accessories, microphones, communication devices and instruments

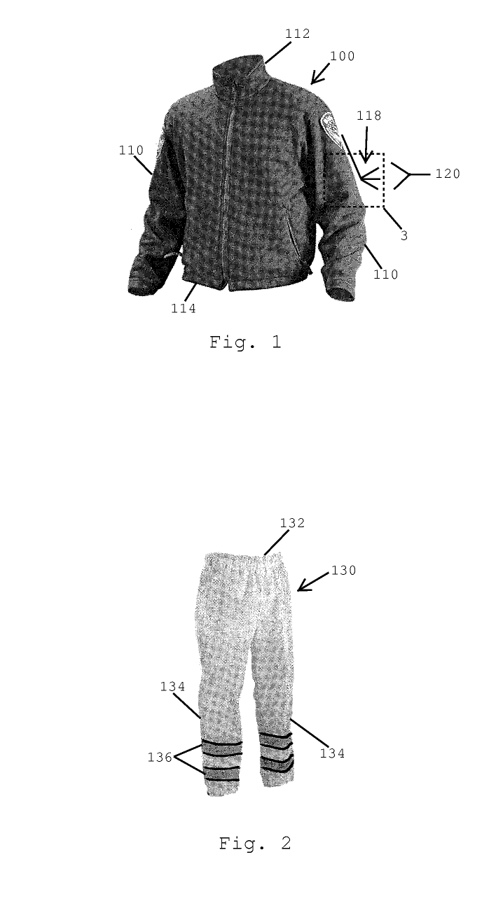

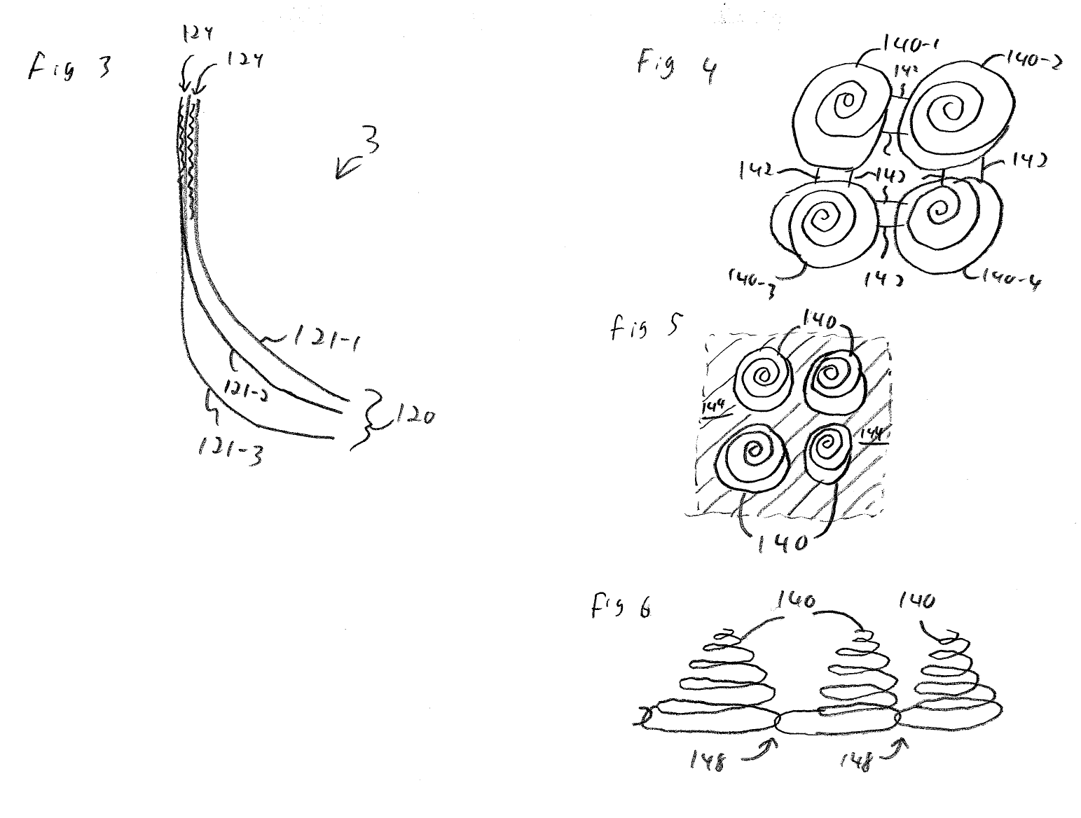

FIG. 1 is a diagram of an upper portion of the uniform. Referring to FIG. 1, the upper portion 100 generally takes the form of a shirt or jacket for covering an upper torso of the wearer. Sleeves 110, collar 112 and waistband/tail 114 outfit the wearer as a typical garment, however providing protection via a construction 3 of a plurality of layers 120, discussed further below in FIG. 3. Generally, the layers 120 provide safety, mobility and identification of first responders such as EMTs and police. FIG. 2 is a diagram of a lower portion 130 of the uniform, and takes the form of pants or trousers for protecting the lower torso and legs of the wearer. A waistband 132 adapts to the midsection of the wearer, and pant legs 134 cover the legs of the wearer. Reflective stripes 136 provide visual identification and may complement a color scheme identifying the function of the wearer, i.e. EMS, police, fire, etc.

In the example arrangement, therefore, the upper and lower portions define a protective garment constructed of a protective material 118 having a plurality of layers including a toxicity barrier adapted for visual contrast with toxic substances, such that the toxicity barrier is responsive to toxic substances by varying a response to a detection stimulus. The response may be a color change of the material, and may be activated by fluorescent, ultraviolet (UV) light or other form of a detection stimulus, such as liquid or gaseous detection mediums. The detection stimulus identifies the presence of the toxic substance absorbed or deposited on the toxicity barrier so that subsequent contact may be avoided and/or at least identified. In a typical usage, the toxic substances include human blood, a condition often encountered by EMTs at trauma and accident scenes, or mass-gathering disasters.

The layers also include an impact layer responsive to breach by harmful objects by preventing passage of harmful objects through the impact layer. EMTs, fire and police often respond to victims in areas still unsecured from the events that harmed the victims. Projectiles from firearm (gun) activity is a prominent concern for first responders, as well as close range weapons such as knives, which may be wielded by subjects in the accident scene. Due to the exigent response required at trauma scenes, the stability and state of mind of the uninjured is often unknown, and first responders and other members of public safety responders may be at risk from residual hostilities and/or subjects who are unaware about the benign nature of the functions of pre-hospital providers.

An absorbent layer is innermost and adjacent to or nearest to the skin surface of the wearer. Accordingly, this layer is responsive to expelled fluids of the wearer, such as sweat, and is adapted for unidirectional diffusion of fluids to provide breathability. The absorbent later also repels outside fluids, such as rain or toxins, but allows vapor permeation (in conjunction with the other layers) to maintain wearer comfort. The layered construction is discussed in further detail with respect to FIG. 3, below.

FIG. 3 shows layered construction of the uniform material. Referring to FIGS. 1-3, the cutaway portion 3 shows the plurality of layers 120 in the construction of the protective garment. In the example arrangement, the outermost layer 121-1 defines the toxicity barrier, the middle layer 121-2 protects against impact and projectile (the “impact layer”) and the innermost layer 121-3 is operative as an absorbent layer in contact or communication (via an undergarment) with the wearer. Other or additional layers may be added in alternate configurations. Flexibility of movement and avoidance of binding or hindering movement are paramount in the construction of the layers. Accordingly, the layers 120 are bonded together using a resilient bonding 124 between the layers 120. As indicated above, the bonding 124 or other attachment may be selective, as in only at seams and/or sewn areas, and is breathable so as not to interfere with the unidirectional diffusion property of the innermost layer 121-3.

In the example of FIG. 3, the layers 120 may be bonded together by a resilient medium for permitting flexibility and wearer mobility. The bonding 124 defines an attachment that may be a continuous polymer or adhesive, or may also be performed at particular areas such as seams. The bonding is non-interfering with the function of the other layers, for example it does not impede the permeability or breathability of the absorbent layer 121-3.

The absorbent layer 121-3 is responsive to sweat of the wearer by passing liquid away from the wearer and preventing skin contact with the expelled fluids. The unidirectional nature is such that the unidirectional barrier also disposes fluids away from the wearer for both internally generated and externally applied fluids, such as toxic substances intercepted by the toxicity barrier layer 121-1. The layered construction may also include a coating on at least one of the layers adapted to repel water and other liquids without hindering vapor permeability of other layers 120.

The toxicity barrier layer 121-1 is sensitive to an external stimuli directed at the toxicity barrier, such that the varied response is indicative of a presence of a toxic substance. EMTs and other members of public safety responders may be unaware of contact with potentially hazardous substances such as blood and contaminated waste. Following the exigency of a response situation, a stimuli such as a UV light may be focused on the toxicity barrier layer 121-1 to confirm whether contamination with toxic substances occurred. In this manner, the toxicity barrier layer 121-1 is responsive by varying a response to an optical signal directed at the toxicity barrier layer 121-1. The optical signal may be a detection light, such as a UV, fluorescent, or other radiant source for activating fibers in the toxicity barrier. The response to toxic fluids may be facilitated by complementary coatings on the toxicity barrier layer 121-1, or may trigger a response in the toxic substance itself. Therefore, depending on the construction, the toxicity barrier layer 121-1 may exhibit sensitivity to fluids resulting from added reactive luminescent compound, or may exhibit sensitivity to fluids resulting from retention of fluid until detectable by luminescent property of fluid substance absorbed by the toxicity barrier. In other words, the toxic substance may itself respond, or glow, in the presence of the light source.

FIG. 4 shows construction of a particular layer for absorbing impact. In FIG. 4, a plurality of impact elements 140-1 . . . 140-4 (140 generally), such as metal springs or coils, are connected by linkages 142. The impact elements 140 form a mesh or network for preventing penetration by projectiles such as bullets or blades of hand weapons such as knives. The impact absorbing later therefore exhibits bulletproof properties by any suitable construction or arrangement of impact elements 140. The impact layer 121-2 is therefore adapted for resilient response to projectiles such as bullets and shrapnel, for example. In the example of FIG. 4, the impact layer 121-2 is responsive to projectiles by controlled deformation, such that the controlled deformation prevents passage of the projectile by absorbing energy from the projectile. The impact layer 121-2 therefore defines a network or mesh of interconnected coiled elements, such that each of the coiled elements adapted for controlled deformation, for example by the metal spring compressing and remaining coupled to adjacent springs.

FIG. 5 shows an alternate arrangement of the impact absorbing layer embedded in a resilient material. In the example of FIG. 5, the impact layer 121-2 includes a plurality of springs embedded in a resilient material, such that the springs having an axis normal to a plane defined by the resilient material. The impact elements 140 are embedded or integrated in a resilient foundation 144 for securing and maintaining the elements. The resilient foundation 144 may be a polymer based or fibrous composition for imparting strength and elasticity to the impact layer 121-2. Compositions including Kevlar®, fiberglass or carbon fiber may also be employed.

FIG. 6 shows another alternate configuration of the impact absorbing layer with interlocking elements. In FIG. 6, a side view of the elements 140 shows a tapered or graduated structure of the elements (coils) 140. The tapered, converging (conelike) shape of the elements 140 provide a graduated resistance to penetration. The elements 140 are connected to adjacent elements via interlocks 148, which may intertwined coils or may include a more rigid connection. FIG. 6 illustrates construction in which the impact layer 121-2 disposes the coiled elements, or impact elements 140, such that a continuous interlocking of elements 140 provides resistance to cutting edges drawn across the surface.

The disclosed uniform also exhibits a method of manufacturing a protective uniform for safety, mobility and identification of the wearer including constructing an external toxicity barrier layer adapted for visual contrast with toxic substances, such that the toxicity barrier is responsive to toxic substances by varying a response to a detection stimulus such as UV light. The method also constructs an intermediate impact layer responsive to breach by harmful objects by preventing passage of harmful objects through the protective layer, and constructs an internal absorbent layer responsive to expelled fluids of the wearer, such that the absorbent layer is adapted for unidirectional diffusion of fluids. An assembly process bonds the layers together by a resilient medium for permitting flexibility and wearer mobility, in which the outermost layer defines a surface barrier for contact with external harmful substances, the internal absorbent layer in communication with the wearer, and the intermediate layer bonded between the toxicity barrier and absorbent layers.

Particular configurations include selecting a color scheme for identifying first responders by an implemented standard of appearance for EMTs and other members of public safety responders by promulgating uniforms of a common color. The common color is ideally certified by obtaining compliance from a body of unrelated organizations for common identification for like functions (e.g. EMT, fire, police, etc). A universal standard for EMTs and other public safety responders facilitates recognition to communicate the nature of the EMTs presence and activity, and wards off hostile activities directed toward the EMTs and public safety responders. Conventional approaches entail multiple EMT groups or teams, resulting from municipality employees, volunteers and private ambulance companies hired as contractors. The result is many different uniforms and appearances for EMTs and public safety responders, which can lead to confusion and ambiguity when attempting to distinguish EMT personnel or public safety responders in an exigent situation.

What is claimed is:

1. A protective garment comprising:
a plurality of layers including:
a toxicity barrier layer adapted for visual contrast with toxic substances, the toxicity barrier responsive to toxic substances by varying a response to a detection stimulus;
an impact layer responsive to breach by harmful objects by preventing passage of harmful objects through the impact layer; and
an absorbent layer responsive to expelled fluids of the wearer, the absorbent layer adapted for unidirectional diffusion of fluids.

2. The garment of claim 1 wherein the impact layer includes a plurality of springs embedded in a resilient material, the elastic springs having an axis normal to a plane defined by the resilient material.

3. The garment of claim 1 wherein the impact layer is adapted for resilient response to projectiles.

4. The garment of claim 3 wherein the impact layer is responsive to projectiles by controlled deformation, the controlled deformation preventing passage of the projectile by absorbing energy from the projectile.

5. The garment of claim 4 wherein the impact layer further comprises a network of interconnected coiled elements, each of the coiled elements adapted for controlled deformation.

6. The garment of claim 5 wherein the impact layer disposes the coiled elements such that a continuous interlocking of elements provides resistance to cutting edges drawn across the surface.

7. The garment of claim 1 wherein the toxicity barrier layer is sensitive to an external stimuli directed at the toxicity barrier, the varied response indicative of a presence of a toxic substance.

8. The garment of claim 7 wherein the toxicity barrier layer is responsive by varying a response to an optical signal directed at the toxicity barrier layer.

9. The garment of claim 8 wherein the optical signal is a detection light for activating fibers in the toxicity barrier.

10. The garment of claim 7 wherein the toxicity barrier layer exhibits sensitivity to fluids resulting from added reactive luminescent compound in the toxicity barrier.

11. The garment of claim 7 wherein a sensitivity to fluids results from retention of a fluid substance until detectable by luminescent property of the fluid substance absorbed by the toxicity barrier.

12. The garment of claim 1 wherein the plurality of layers are bonded together by a resilient medium for permitting flexibility and wearer mobility.

13. The garment of claim 1 wherein the absorbent layer is responsive to sweat of the wearer by passing liquid away from the wearer and preventing skin contact with the expelled fluids.

14. The garment of claim 13 wherein the absorbent layer disposes fluids away from the wearer for both internally generated and externally applied fluids.

15. The garment of claim 14 further comprising a coating on at least one of the layers adapted to repel water without hindering vapor permeability of other layers.

16. A method of manufacturing a protective uniform for safety, mobility and identification of the wearer comprising:
constructing an external toxicity barrier layer adapted for visual contrast with toxic substances, the toxicity barrier responsive to toxic substances by varying a response to a detection stimulus;
constructing an intermediate impact layer responsive to breach by harmful objects by preventing passage of harmful objects through the impact layer; and
constructing an internal absorbent layer responsive to expelled fluids of the wearer, the absorbent layer adapted for unidirectional diffusion of fluids;
bonding the layers together by a resilient medium for permitting flexibility and wearer mobility, such that the outermost layer is the external layer for contact with external harmful substances, the internal absorbent layer in communication with the wearer, and the intermediate layer bonded between the toxicity barrier and absorbent layers.

17. The method of claim 16 wherein constructing the intermediate impact layer includes embedding plurality of springs in a resilient material, such that the springs have an axis normal to a plane defined by the resilient material, the impact layer is adapted for resilient response to projectiles by controlled deformation, the controlled deformation preventing passage of the projectile by absorbing energy from the projectile.

18. The method of claim 17 further comprising constructing the toxicity barrier layer by imparting sensitivity to an external stimuli directed at the toxicity barrier layer, the varied response indicative of a presence of a toxic substance, such that the toxicity barrier layer is responsive by varying a response to an optical signal directed at the toxicity barrier layer.

19. The method of claim 16 further comprising:
selecting a color scheme for identifying first responders by an implemented standard of appearance for the first responders by promulgating uniforms of a common color; and
obtaining compliance from a body of unrelated organizations for common identification for like functions.

20. In an exigent environment, a protective uniform for safety, mobility and identification of first responders comprising protective garment comprising:
a plurality of layers including:
a toxicity barrier adapted for visual contrast with toxic substances, the toxicity barrier responsive to toxic substances by varying a response to an optical signal;
an elastic impact layer responsive to projectiles by controlled deformation, the controlled deformation preventing passage of the projectile; and
an absorbent layer responsive to expelled fluids of the wearer, the absorbent layer adapted for unidirectional diffusion of fluids.
